(19) United States
(12) Patent Application Publication
(10) Pub. No.: US 2016/0303913 A1
(43) Pub. Date: Oct. 20, 2016

(54) Tire Comprising Carcass Reinforcing Cords Of Low Permeability And Variable Thicknesses Of Rubber Compound

(71) Applicants: COMPAGNIE GENERALE DES ETABLISSEMENTS MICHELIN, Clermont-ferrand (FR); MICHELIN RECHERCHE ET TECHNIQUE S.A., Granges-paccot (CH)

(72) Inventors: Charlotte CAFFEAU, Clermont-Ferrand Cedex 9 (FR); Michaël COGNE, Clermont-Ferrand Cedex 9 (FR); Jean BERANGER, Clermont-Ferrand Cedex 9 (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/101,700

(22) PCT Filed: Nov. 25, 2014
(86) PCT No.: PCT/EP2014/075538

§ 371 Date: Jun. 3, 2016

(30) Foreign Application Priority Data
Dec. 3, 2013 (FR) 1361982

(51) Int. Cl. B60C 9/08; B60C 11/00; B60C 9/20; B60C 13/00; B60C 1/00; B60C 9/22; B60C 9/00; B60C 15/00

(52) U.S. Cl. CPC B60C 9/08; B60C 9/0007; B60C 11/00; B60C 15/00; B60C 13/00; B60C 9/005; B60C 1/00; B60C 9/22; B60C 9/20; B60C 9/2003; B60C 2009/0475

(57) ABSTRACT

Tire with a radial carcass reinforcement, made up of at least one layer of metal reinforcing elements, the tire comprising a crown reinforcement, itself radially capped by a tread, the tread being connected to two beads by two sidewalls. The metal reinforcing elements of at least one layer of the carcass reinforcement are non-wrapped cords which, in the test referred to as the permeability test, return a flow rate of less than 20 cm³/min, in a radial plane, at least over part of the meridian profile of the tire, the thickness of rubber compound between the interior surface of the cavity of the tire and the point of a metal reinforcing element of the carcass reinforcement closest to the interior surface of the cavity is less than or equal to 3.8 mm and the ratio between the thickness of rubber compound measured at the circumferential mid plane and the said thickness measured in another region of the tire is greater than 1.05.

The present invention relates to a tire with a radial carcass reinforcement, and more particularly to a tire intended for fitting to vehicles carrying heavy loads and travelling at sustained speeds, such as lorries, tractors, trailers or buses, for example.

In the tires of heavy-duty vehicles, the carcass reinforcement is generally anchored on either side in the area of the bead and is surmounted radially by a crown reinforcement made up of at least two layers that are superimposed and formed of threads or cords which are parallel in each layer and crossed from one layer to the next, forming angles of between 10° and 45° with the circumferential direction. The said working layers that form the working reinforcement may be further covered by at least one layer, referred to as the protective layer, formed by reinforcing elements which are advantageously metallic and extensible and are referred to as elastic reinforcing elements. It may also comprise a layer of metal threads or cords having low extensibility, forming an angle of between 45° and 90° with the circumferential direction, this ply, called the triangulation ply, being located radially between the carcass reinforcement and the first crown ply, referred to as the working ply, formed by parallel threads or cords lying at angles not exceeding 45° in terms of absolute value. The triangulation ply forms a triangulated reinforcement with at least the said working ply, this reinforcement having low deformation under the various stresses which it undergoes, the triangulation ply essentially serving to absorb the transverse compressive forces acting on all the reinforcing elements in the crown area of the tire.

In the case of tires for “heavy-duty” vehicles, just one protective layer is usually present and its protective elements are, in the majority of cases, oriented in the same direction and with the same angle in terms of absolute value as those of the reinforcing elements of the radially outermost and thus radially adjacent working layer.

The circumferential direction of the tire, or longitudinal direction, is the direction corresponding to the periphery of the tire and defined by the direction in which the tire runs.

The transverse or axial direction of the tire is parallel to the axis of rotation of the tire.

The radial direction is a direction intersecting the axis of rotation of the tire and perpendicular thereto.

The axis of rotation of the tire is the axis about which it turns in normal use.

A radial or meridian plane is a plane which contains the axis of rotation of the tire.

The circumferential mid plane, or equatorial plane, is a plane which is perpendicular to the axis of rotation of the tire and divides the tire into two halves.

Some current tires, referred to as “road” tires, are intended to run at high speed and over increasingly long journeys, as a result of the improvement in the road network and of the growth of the motorway network throughout the world. The combined conditions under which such a tire is called upon to run undoubtedly allows an increase in the distance covered since tire wear is lower although, on the other hand, the endurance of the tire is detrimentally affected. In order to allow one, indeed even two, retreadings of such tires in order to lengthen their life, it is necessary to retain a structure and in particular a carcass reinforcement the endurance properties of which are sufficient to withstand the said retreadings.

Prolonged running under particularly severe conditions of the tires thus constructed effectively results in limits appearing regarding the endurance of these tires.

The elements of the carcass reinforcement are in particular subjected to bending and compressive stresses during running which adversely affect their endurance. Specifically, the cords which form the reinforcing elements of the carcass layers are subjected to high stresses during the running of the tires, in particular to repeated bending actions or variations in curvature, resulting in friction at the threads and thus in wear, and also in fatigue; this phenomenon is described as “fatigue-fretting”.

In order to perform their role of strengthening the carcass reinforcement of the tire, the said cords first of all have to exhibit good flexibility and a high flexural endurance, which implies in particular that their threads exhibit a relatively small diameter, preferably of less than 0.28 mm, more preferably of less than 0.25 mm, generally smaller than that of the threads used in conventional cords for crown reinforcements of tires.

The cords of the carcass reinforcement are also subject to “fatigue-corrosion” phenomena due to the very nature of the cords, which favor the passage of and, indeed even drain, corrosive agents, such as oxygen and moisture. This is because the air or the water which penetrates into the tire, for example when damaged by a cut or more simply as the result of the permeability, even through low, of the interior surface of the tire, can be conveyed by the channels formed within the cords by the very fact of their structure.

All these fatigue phenomena, which are generally grouped together generally under the generic term of “fatigue-fretting-corrosion”, cause a progressive deterioration in the mechanical properties of the cords and can, for the most severe running conditions, affect the life of the cords.

In order to improve the endurance of these cords of the carcass reinforcement, it is known in particular to increase the thickness of the layer of rubber which forms the internal wall of the cavity of the tire in order to limit as much as possible the permeability of the said layer. This layer is usually partly composed of butyl, so as to increase the air tightness of the tire. This type of material exhibits the disadvantage of increasing the cost of the tire.

It is also known to modify the construction of the said cords in order in particular to increase their penetrability by the rubber and thus limit the passage of oxidizing agents.

Moreover, it has become apparent in the latter instance during running under particularly harsh conditions, particularly in terms of inflation and load borne, that the endurance of the crown reinforcement may be adversely affected.

The inventors thus set themselves the task of providing tires for heavy vehicles of “heavy-duty” type, the wear performance of which is retained for road use and the endurance performance of which is improved in particular from the viewpoint of the “fatigue-corrosion” or “fatigue-fretting-corrosion” phenomena, whatever the running conditions, notably in terms of inflation and load borne, and for which the manufacturing cost remains acceptable.

This objective has been achieved according to the invention using a tire with a radial carcass reinforcement, made up of at least one layer of metal reinforcing elements, the said tire comprising a crown reinforcement formed of at least two working crown layers of reinforcing elements which are crossed from one layer to the other, making with the circumferential direction angles of between 10 and 45°, and itself radially capped by a tread, the said tread being connected to two beads by two sidewalls, the metal reinforcing elements of at least one layer of the carcass reinforcement being non-wrapped cords which, in the test referred to as the permeability test, return a flow rate of less than 20 cm³/min, in a radial plane, at least over part of the meridian profile of the tire, the thickness of rubber compound between the interior surface of the cavity of the tire and the point of a metal reinforcing element of the carcass reinforcement closest to the said interior surface of the cavity being less than or equal to 3.8 mm and, in a radial plane, the ratio between the thickness of rubber compound at the circumferential mid plane between the interior surface of the cavity of the tire and the point of a metal reinforcing element of the carcass reinforcement closest to the said interior surface of the cavity and the thickness of rubber compound measured in another region of the tire between the interior surface of the cavity of the tire and the point of a metal reinforcing element of the carcass reinforcement closest to the said interior surface of the cavity being greater than 1.05.

The test referred to as the permeability test makes it possible to determine the longitudinal permeability to air of the cords tested, by measuring the volume of air passing along a test specimen under constant pressure over a given period of time. The principle of such a test, which is well known to those skilled in the art, is to demonstrate the effectiveness of the treatment of a cord to make it impermeable to air; it has been described for example in standard ASTM D2692-98.

The test is carried out on cords extracted directly, by stripping, from the vulcanized rubber plies which they reinforce, thus penetrated by the cured rubber.

The test is carried out on a 2 cm length of cord, which is therefore coated with its surrounding rubber composition (or coating rubber) in the cured state, in the following way: air is sent to the inlet of the cord, under a pressure of 1 bar, and the volume of air at the outlet is measured using a flow meter (calibrated, for example, from 0 to 500 cm³/min) During the measurement, the sample of cord is immobilized in a compressed airtight seal (for example, a seal made of dense foam or of rubber) so that only the amount of air passing along the cord from one end to the other, along its longitudinal axis, is taken into account by the measurement; the air tightness of the airtight seal itself is checked beforehand using a solid rubber test specimen, that is to say one devoid of cord.

The lower the mean air flow rate measured (mean over 10 test specimens), the higher the longitudinal impermeability of the cord. As the measurement is carried out with an accuracy of ±0.2 cm³/min, measured values less than or equal to 0.2 cm³/min are regarded as zero; they correspond to a cord which can be described as airtight (completely airtight) along its axis (i.e. in its longitudinal direction).

This permeability test also constitutes a simple means of indirect measurement of the degree of penetration of the cord by a rubber composition. The lower the flow rate measured, the greater the degree of penetration of the cord by the rubber.

Cords which in the test referred to as the permeability test return a flow rate of less than 20 cm³/min have a degree of penetration higher than 66%.

The degree of penetration of a cord can also be estimated according to the method described below. In the case of a layered cord, the method consists, in a first step, in removing the outer layer from a sample with a length of between 2 and 4 cm in order to subsequently measure, in a longitudinal direction and along a given axis, the sum of the lengths of rubber compound in relation to the length of the sample. These measurements of lengths of rubber compound exclude the spaces not penetrated along this longitudinal axis. These measurements are repeated along three longitudinal axes distributed over the periphery of the sample and are repeated on five samples of cord.

When the cord comprises several layers, the first step of removal and the measurements of lengths of rubber compound along longitudinal axes are repeated with what is now the outer layer.

A mean of all the ratios of lengths of rubber compound to lengths of samples thus determined is then calculated in order to define the degree of penetration of the cord.

The thickness of rubber compound between the interior surface of the tire cavity and the point of a reinforcing element that is closest to the said surface is equal to the length of the orthogonal projection onto the interior surface of the tire cavity of the end of the point of a reinforcing element that is closest to the said surface.

The measurements of the thickness of rubber compound are carried out on a cross section of a tire, the tire thus being in a non-inflated state.

According to one advantageous embodiment of the invention, the thickness of rubber compound between the interior surface of the cavity of the tire and the point of a metal reinforcing element of the carcass reinforcement closest to the said interior surface of the cavity is less than or equal to 3.8 mm over at least two thirds of the meridian profile of the tire.

For preference according to the invention, in radial plane, at least over part of the meridian profile of the tire, the thickness of rubber compound between the interior surface of the cavity of the tire and the point of a metal reinforcing element of the carcass reinforcement closest to the said interior surface of the cavity is less than or equal to 3.6 mm and more preferably still, less than or equal to 3.4 mm

The inventors have been able to demonstrate that a tire thus produced according to the invention results in highly advantageous improvements in terms of the compromise between endurance and manufacturing costs. Specifically, the endurance properties with such a tire are at least as good as with the best solutions mentioned hereinabove whether this be under normal running conditions or even under running conditions that are more harsh in terms of load and/or of inflation. Moreover, since the thickness of the layer of rubber compound between the carcass reinforcement and the cavity of the tire is at least locally reduced in comparison with conventional tires and because this layer is one of the most expensive components of the tire, the cost of manufacture of the tire is lower than that of a conventional tire. The carcass reinforcement cords which, in the test referred to as the permeability test, return a flow rate of less than 20 cm³/min make it possible to limit the risks associated with corrosion thus making it possible to minimize the thickness of the rubber compounds between the interior surface of the cavity of the tire and the carcass reinforcement.

Finally, the inventors have demonstrated that, under particularly harsh running conditions, notably in terms of inflation, reducing the thicknesses of rubber compounds between the interior surface of the cavity of the tire and the carcass reinforcement could lead to damage to the crown reinforcement and notably to the reinforcing elements of the working layers in the equatorial plane.

The inventors believe that this phenomenon can be interpreted as being due to the nature of the rubber compounds between the interior surface of the cavity of the tire and the carcass reinforcement. Conventional tire designs combine two compounds, a first compound forming the actual wall of the cavity of the tire intended to form an airtight layer. This type of compound is usually based on butyl and constitutes one of the most expensive elements of the tire. The second compound in contact with the carcass reinforcement is a compound of the oxygen-trap type and makes it possible to slow the migration of oxidizing elements. The inventors, noting that the effectiveness of this second compound is all the higher if its temperature is high, have been able to demonstrate that beyond a certain reduction in thickness its effectiveness becomes insufficient, notably in the region of the equatorial plane, which is one of the regions of the tire in which the temperature is the least high. The combination of a reduction in thickness of the two types of layer of compound combined with particularly harsh conditions of use has led the inventors to the observation that there is a thickness limit that should advantageously not be crossed at the risk of penalizing not the carcass reinforcement which appears to be well protected because of the cords which, in the test referred to as the permeability test, return a low rate of less than 20 cm³/min, but the crown reinforcement.

The ratio between the thickness of rubber compound in the circumferential mid plane between the interior surface of the cavity of the tire and the point of a metal reinforcing element of the carcass reinforcement closest to the said interior surface of the cavity and the thickness of rubber compound measured in another region of the tire between the interior surface of the cavity of the tire and the point of a metal reinforcing element of the carcass reinforcement closest to the said interior surface of the cavity greater than 1.05, corresponding to an overthickness of the said compounds between the interior surface of the cavity of the tire and the carcass reinforcement at the equatorial plane in comparison with the thickness in other regions of the tire, makes it possible to produce tires with satisfactory crown reinforcement endurance performance

According to one preferred embodiment of the invention, in a radial plane, on the said part of the meridian profile of the tire in which the thickness of rubber compound between the interior surface of the cavity of the tire and the point of a metal reinforcing element of the carcass reinforcement closest to the said interior surface of the cavity is less than or equal to 3.8 mm, the said thickness is greater than 2.4 mm and preferably greater than 3 mm

Advantageously according to the invention, in the circumferential mid plane, the overthickness of compounds between the interior surface of the cavity of the tire and the carcass reinforcement in comparison with the other regions of the tire is obtained by an increase in the thickness of the layer of compound that provides the air tightness and that forms the surface of the wall of the cavity of the tire. Indeed the inventors have been able to demonstrate that it was more advantageous to increase the thickness of this compound, even though it is the most expensive, because it is more effective than the second compound for the reasons listed hereinabove.

This overthickness can be obtained in various ways while the tire is being manufactured. A first method consists in producing the layer of rubber compound that forms the wall of the tire cavity with the desired profile to form these overthicknesses. Another method is to produce this region of overthickness by adding additional layers of rubber compounds locally.

Advantageously, according to the invention, in a radial plane, the part of the meridian profile of which the thickness of rubber compound between the interior surface of the cavity of the tire and the point of a metal reinforcing element of the carcass reinforcement closest to the said interior surface of the cavity is greater than at least 1.05 times the thickness of rubber compound between the interior surface of the cavity of the tire and the point of a metal reinforcing element of the carcass reinforcement closest to the said interior surface of the cavity of a said other region of the tire is centered on the circumferential mid plane.

Advantageously too according to the invention, the axial width of the said part of the meridian profile of the tire that is centered on the circumferential mid plane is greater than 20% of the axial width of the widest working layer.

According to one preferred embodiment of the invention, in a radial plane, over at least the part of the meridian profile of the tire over which the thickness of rubber compound between the interior surface of the cavity of the tire and the point of a metal reinforcing element of the carcass reinforcement closest to the said interior surface of the cavity is less than or equal to 3.8 mm, the thickness of the rubber compound forming the interior surface of the cavity of the tire is less than 2 mm and preferably less than or equal to 1.7 mm

This preferred embodiment of the invention, whereby the reduction in thickness of the rubber compound forming the interior surface of the cavity of the tire, usually made of butyl which is a material of which the cost is not insignificant in the makeup of the tire, to values of less than 2 mm over part of the meridian profile of the tire advantageously leads to a lower cost for the tire.

For preference too, according to the invention, in the region of the parts of the meridian profile of the tire that have a thickness of rubber compound between the interior surface of the cavity of the tire and the point of a metal reinforcing element of the carcass reinforcement closest to the said interior surface of the cavity that is less than or equal to 3.8 mm, the layer of rubber compound radially adjacent to the radially innermost layer of rubber compound has a thickness of less than 2.5 mm and preferably less than 2 mm. The thickness of this layer, the constituents of which notably allow oxygen from the air to be fixed, may also be reduced so as to further reduce the cost of the tire.

The thicknesses of each of these two layers are equal to the length of the orthogonal projection of a point of a surface onto the other surface of the said layer.

Advantageously according to the invention, in a radial plane, the ratio between the thickness of the rubber compound forming the interior surface of the cavity of the tire measured at the circumferential mid plane and the thickness of the rubber compound forming the interior surface of the cavity of the tire measured in another region of the tire is greater than 1.1.

According to an advantageous embodiment of the invention, the metal reinforcing elements of at least one layer of the carcass reinforcement are cords having at least two layers, at least one inner layer being sheathed with a layer consisting of a non-crosslinkable, crosslinkable or crosslinked rubber composition, preferably based on at least one diene elastomer.

According to a preferred embodiment of the invention, the cords of the carcass reinforcement in the test referred to as the permeability test return a flow rate of less than 10 cm³/min and more preferably of less than 2 cm³/min.

The invention further proposes a tire with a radial carcass reinforcement, made up of at least one layer of reinforcing elements, the said tire comprising a crown reinforcement, itself capped radially by a tread, the said tread being connected to two beads by two sidewalls, the metal reinforcing elements of at least one layer of the carcass reinforcement being non-wrapped cords having at least two layers, at least one inner layer being sheathed with a layer made up of a non-crosslinkable, crosslinkable or crosslinked rubber composition, preferably based on at least one diene elastomer, in a radial plane, at least over part of the meridian profile of the tire, the thickness of rubber compound between the interior surface of the cavity of the tire and the point of a metal reinforcing element of the carcass reinforcement closest to the said interior surface of the cavity being less than or equal to 3.8 mm and, in a radial plane, the ratio between the thickness of rubber compound measured at the circumferential mid plane between the interior surface of the cavity of the tire and the point of a metal reinforcing element of the carcass reinforcement closest to the said interior surface of the cavity and the thickness of rubber compound measured in another region of the tire between the interior surface of the cavity of the tire and the point of a metal reinforcing element of the carcass reinforcement closest to the said interior surface of the cavity being greater than 1.05.

Within the meaning of the invention, cords, having at least two layers, at least one inner layer being sheathed with a layer consisting of a polymer composition, return, in the test referred to as the permeability test, a flow rate of less than 20 cm³/min and advantageously of less than 2 cm³/min.

The expression “composition based on at least one diene elastomer” means, in a known way, that the composition has a majority content (i.e. a fraction of more than 50% by weight) of this or these diene elastomers.

It should be noted that the sheath according to the invention extends continuously around the layer that it covers (that is to say that this sheath is continuous in the “orthoradial” direction of the cord which is perpendicular to its radius), so as to form a continuous sleeve having a cross section which is advantageously practically circular.

It should also be noted that the rubber composition of this sheath may be crosslinkable or crosslinked; in other words, comprises, by definition, a crosslinking system adapted to allow the composition to be crosslinked in the course of its curing (i.e. for it to harden, not melt); thus this rubber composition may be described as non-meltable, because it cannot be melted by heating, regardless of the temperature.

The term “diene” elastomer or rubber denotes, in a known way, an elastomer which is based, at least in part (that is to say, is a homopolymer or a copolymer of), on diene monomers (monomers with two carbon-carbon double bonds, which may or may not be conjugated).

For preference, the system for crosslinking the rubber sheath is what is known as a vulcanization system, in other words one which is based on sulphur (or a sulphur-donating agent) and a primary vulcanization accelerator. Various known vulcanization activators or secondary accelerators may be added to this basic vulcanization system.

The rubber composition of the sheath according to the invention may comprise, in addition to the said crosslinking system, all the customary ingredients that can be used in rubber compositions for tires, such as reinforcing fillers based on carbon black and/or an inorganic reinforcing filler such as silica, anti-ageing agents such as antioxidants, extending oils, plasticizers or agents facilitating the working of the compositions in the raw state, methylene acceptors and donors, resins, bismaleimides, known adhesion promoters of the “RFS” (resorcinol-formaldehyde-silica) type, or metal salts, notably cobalt salts.

Preferably, the composition of this sheath is chosen to be identical to the composition used for the rubber matrix which the cords according to the invention are intended to reinforce. Thus, there is no problem of possible incompatibility between the respective materials of the sheath and of the rubber matrix.

According to an alternative form of the invention, the metal reinforcing elements of at least one layer of the carcass reinforcement are layered metal cords of [L+M] or [L+M+N] construction that can be used as reinforcing elements in a tire carcass reinforcement, comprising a first layer C1 having L threads of diameter d₁ with L ranging from 1 to 4, surrounded by at least one intermediate layer C2 having M threads of diameter d₂ wound together in a helix at a pitch p₂ with M ranging from 3 to 12, the said layer C2 possibly being surrounded by an outer layer C3 of N threads of diameter d₃ wound together in a helix at a pitch p₃ with N ranging from 8 to 20, a sheath composed of a non-crosslinkable, crosslinkable or crosslinked rubber composition based on at least one diene elastomer covering the said first layer C1 in the [L+M] construction and at least the said layer C2 in the [L+M+N] construction.

For preference, the diameter of the threads of the first layer of the inner layer (C1) is between 0.10 and 0.50 mm and the diameter of the threads of the outer layers (C2, C3) is between 0.10 and 0.50 mm

For preference, too, the helical pitch at which the said threads of the outer layer (C3) are wound is between 8 and 25 mm

Within the meaning of the invention, the helical pitch represents the length, measured parallel to the axis of the cord, at the end of which a thread having this pitch completes a full turn around the axis of the cord; thus, if the axis is sectioned by two planes perpendicular to the said axis and separated by a length equal to the pitch of a thread of a layer forming the cord, the axis of this thread has in these two planes the same position on the two circles corresponding to the layer of the thread in question.

Advantageously, the cord has one, or even more preferably all, of the following characteristics:
the layer C3 is a saturated layer, that is to say that there is not enough room in this layer to add thereto at least one (N+1)th thread of diameter d₃, N then representing the maximum number of threads that can be wound in a layer around the layer C2;
the rubber sheath also covers the internal layer C1 and/or separates the adjacent pairs of threads of the intermediate layer C2;
the rubber sheath practically covers the radially inner semi-circumference of each thread of the layer C3, such that it separates the adjacent pairs of threads of this layer C3.

Preferably, the rubber sheath has a mean thickness ranging from 0.010 mm to 0.040 mm

Generally, the invention can be implemented, to form the cords of the carcass reinforcement which are described above, with metal threads of any type, in particular made of steel, for example threads made of carbon steel and/or threads made of stainless steel. A carbon steel is preferably used, but it is, of course, possible to use other steels or other alloys.

Where a carbon steel is used, its carbon content (% by weight of steel) is preferably in the range from 0.1% to 1.2%, or more preferably from 0.4% to 1.0%; these contents represent a good compromise between the mechanical properties required for the tire and the workability of the thread. It should be noted that a carbon content of between 0.5% and 0.6% ultimately makes such steels less expensive as they are easier to draw.

Another advantageous embodiment of the invention may also consist, depending on the intended applications, in using steels with a low carbon content, for example between 0.2% and 0.5%, notably on account of the lower cost and greater ease of drawing.

The cord according to the invention can be obtained according to various techniques known those skilled in the art, for example in two stages, first of all by sheathing the core or intermediate L+M structure (layers C1+C2) via an extrusion head, which stage is followed, in a second step, by a final operation in which the remaining N threads (layer C3) are cabled or twisted around the layer C2 thus sheathed. The problem of tackiness in the raw state posed by the rubber sheath during any intermediate operations of winding and unwinding may be overcome in a manner known to those skilled in the art, for example by using an interlayer film of plastics material.

One alternative form of the invention, to safeguard against potential use in under inflated mode, provides other regions of the tire in which, in a meridian plane, the ratio between the thickness of rubber compound measured at these said other regions between the interior surface of the cavity of the tire and the point of a metal reinforcing element of the carcass reinforcement closest to the said interior surface of the cavity and the thickness of rubber compound measured in another region of the tire, likewise distinct from the region of the equatorial plane, between the interior surface of the cavity of the tire and the point of a metal reinforcing element of the carcass reinforcement closest to the said interior surface of the cavity is greater than 1.1.

The thickness of rubber compound between the interior surface of the cavity of the tire and the point of a metal reinforcing element of the carcass reinforcement closest to the said interior surface of the cavity is advantageously greater than 3.8 mm in these said other regions.

According to this alternative form of the invention, the thickness of rubber compound between the interior surface of the cavity of the tire and the point of a metal reinforcing element of the carcass reinforcement closest to the said interior surface of the cavity is advantageously greater than 3.8 mm in the parts of the tire that are the most heavily loaded by deformation and notably in the regions of the tire that correspond to the shoulders thereof.

According to this alternative form of the invention, at least two parts of the profile of the tire of which the thickness of rubber compound between the interior surface of the cavity of the tire and the point of a metal reinforcing element of the carcass reinforcement closest to the said interior surface of the cavity is greater than 3.8 mm are centered to within 20 mm, measured along the curvilinear abscissa axis of the interior surface of the cavity of the tire, on the orthogonal projection of the ends of the shoulder of the tire onto the interior surface of the tire.

Within the meaning of the invention, a shoulder end is defined, in the shoulder region of the tire, by the orthogonal projection onto the exterior surface of the tire of the intersection of the tangents to the surfaces of an axially external end of the tread (top of the tread blocks) on the one hand and of the radially external end of a sidewall on the other.

Advantageously too according to this alternative form of the invention, the overthickness of these said other regions, corresponding for example to the shoulders of the tire, are obtained by the addition of compounds which are not based on butyl, so as to limit as far as possible the costs of manufacture of the tire. Indeed the inventors have been able to demonstrate that the effect of the overthickness in this case is an essentially mechanical effect resulting from a local increase in rigidity which helps to combat the deformation imposed on the tire.

According to other alternative embodiments of the invention, the crown reinforcement further comprises at least one layer of circumferential reinforcing elements.

A preferred embodiment of the invention also provides for the crown reinforcement to be supplemented radially on the outside by at least one additional layer, referred to as a protective layer, of reinforcing elements, referred to as elastic, oriented with respect to the circumferential direction at an angle of between 10° and 45° and in the same direction as the angle formed by the inextensible elements of the working layer radially adjacent to it.

The protective layer may have an axial width which is less than the axial width of the least wide working layer. The said protective layer may also have an axial width greater than the axial width of the least wide working layer, such that it covers the edges of the least wide working layer and, if the radially uppermost layer is the least wide layer, such that it is coupled, in the axial extension of the additional reinforcement, to the widest working crown layer over an axial width, and is then decoupled in an axially outermost position from the said widest working layer by profiled elements with a thickness of at least 2 mm In the aforementioned case, the protective layer formed by elastic reinforcing elements may, on the one hand, be decoupled if required from the edges of the said least wide working layer by profiled elements with a thickness substantially less than the thickness of the profiled elements separating the edges of the two working layers, and, on the other hand, have an axial width less than or greater than the axial width of the widest crown layer.

According to any one of the embodiments of the invention mentioned hereinabove, the crown reinforcement may further be supplemented, radially on the inside between the carcass reinforcement and the radially interior working layer closest to the said carcass reinforcement, by a triangulation layer of metal inextensible reinforcing elements made of steel forming, with the circumferential direction, an angle of more than 60° and in the same direction as the direction of the angle formed by the reinforcing elements of the radially closest layer of the carcass reinforcement. Such a triangulation layer may alternatively be produced using two half-layers axially distant from one another and advantageously positioned symmetrically about the circumferential mid plane.

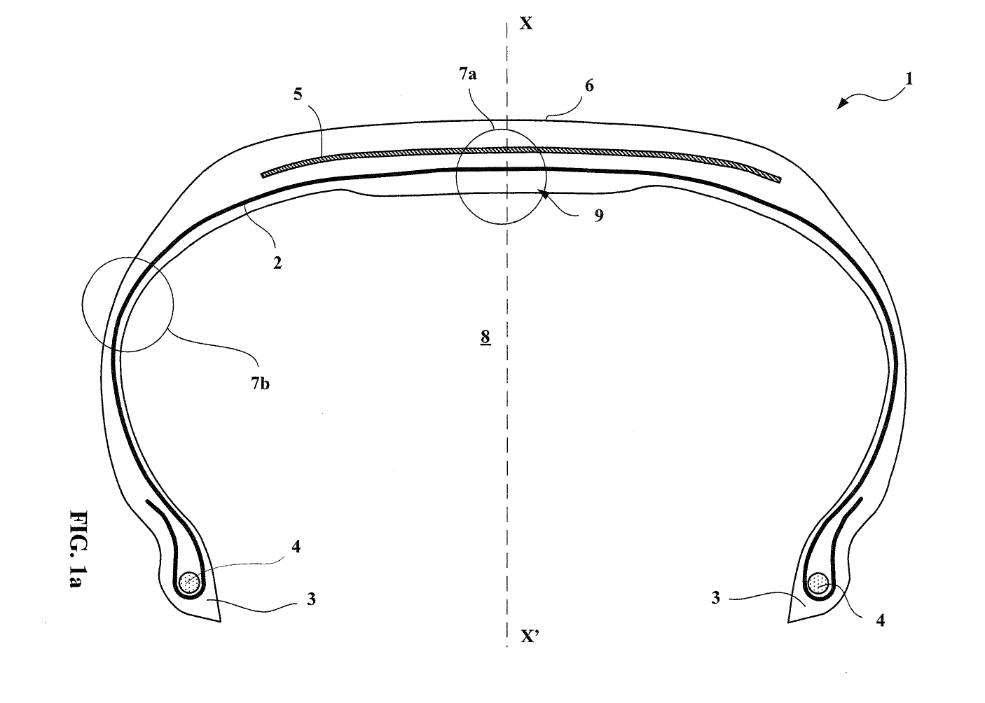

Further details and advantageous features of the invention will become apparent from the following description of exemplary embodiments of the invention, with reference to FIGS. 1 to 3, in which:

FIG. 1a shows a schematic meridian view of a tire according to one embodiment of the invention,

FIG. 1b is an enlarged partial view of a part of the schematic view of FIG. 1a,

FIG. 1c is an enlarged partial view of another part of the schematic view of FIG. 1a,

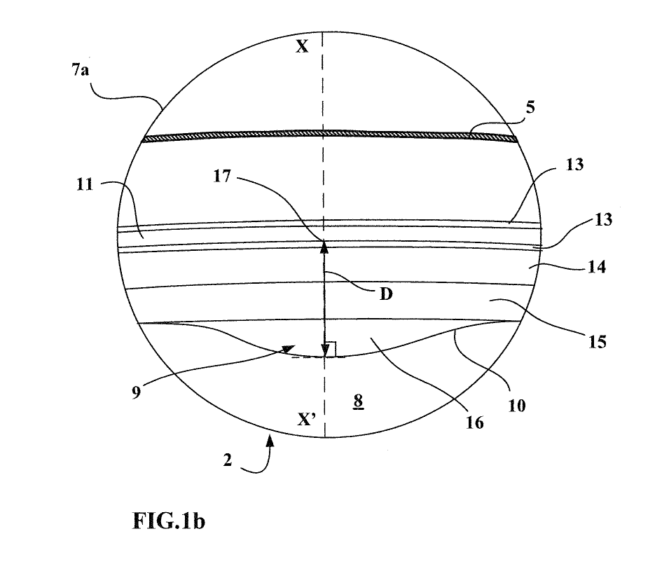

FIG. 2 is a schematic view in cross section of a carcass reinforcement cord of the tire of FIG. 1,

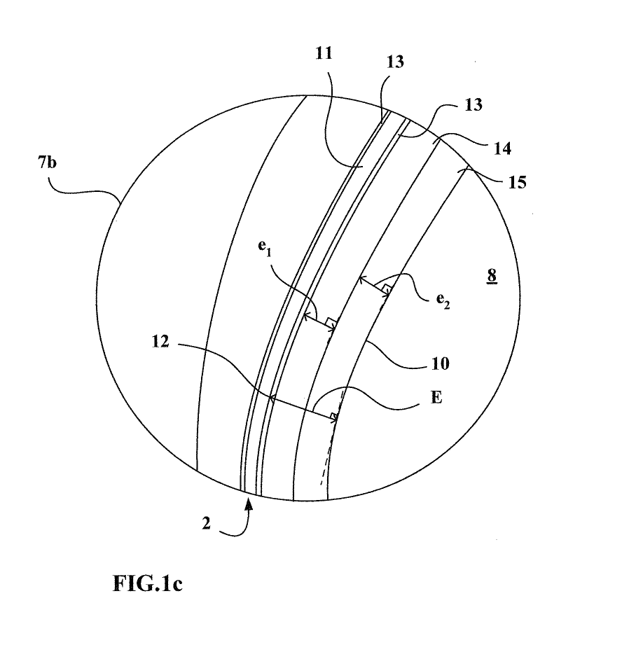

FIG. 3 is a schematic view in cross section of a first other example of a carcass reinforcement cord according to the invention,

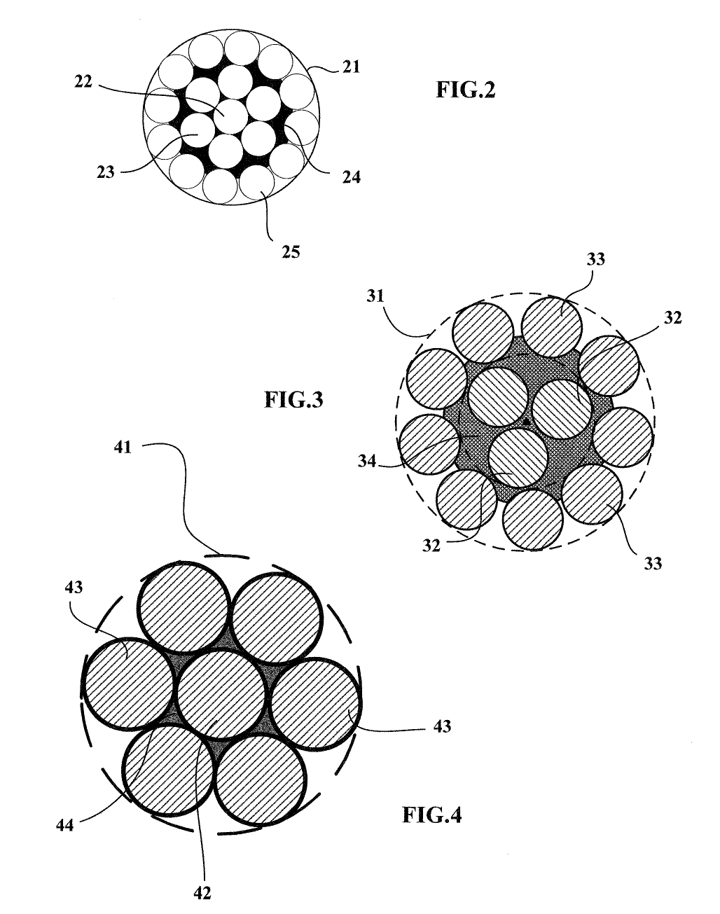

FIG. 4 is a schematic view in cross section of a second other example of a carcass reinforcement cord according to the invention.

In order to make them easier to understand, the figures are not shown to scale.

In FIG. 1a, the tire 1, of size 315/70 R 22.5, comprises a radial carcass reinforcement 2 anchored in two beads 3 around bead wires 4. The carcass reinforcement 2 is formed of a single layer of metal cords 11 and of two calendering layers 13. The carcass reinforcement 2 is hooped by a crown reinforcement 5, itself capped by a tread 6. The crown reinforcement 5 is formed radially, from the inside towards the outside:
of a first working layer formed of non-wrapped inextensible 11.35 metal cords which are continuous across the entire width of the ply, oriented at an angle of 18°,
of a second working layer formed of non-wrapped inextensible 11.35 metal cords which are continuous across the entire width of the ply, oriented at an angle of 18° and crossed with the metal cords of the first working layer,
of a protective layer formed from elastic 6×35 metal cords.

The combination of layers, constituting the crown reinforcement 5, is not depicted in detail in the figures.

The interior surface 10 delimiting the cavity of the tire has an irregularity such as a shape like a boss which, according to the invention, corresponds to a part 9 having a thickness between the interior surface 10 and the carcass reinforcement 2 that is greater than over the rest of the meridian profile of the tire.

FIG. 1b is an enlargement of region 7a of FIG. 1a, this being modified slightly to make the invention easier to understand; specifically, the boss 9 has been reduced in its axial direction to make it more clearly identifiable in this FIG. 1b. This FIG. 1b notably indicates the thickness D of rubber compound between the interior surface 10 of the cavity 8 of the tire and the point 17 of a reinforcing element 11 closest to the said surface 10 at the part 9. This thickness D is equal to the length of the orthogonal projection onto the surface 10 of the point 17 of a reinforcing element 11 that is closest to said surface 10, at the location of the greatest thickness at the part 9. This thickness D is the sum of the thicknesses of the various rubber compounds placed between the said reinforcing element 11 of the carcass reinforcement 2; it corresponds, on the one hand, to the thickness of the calendering layer 13 radially on the inside of the carcass reinforcement and, on the other hand, of the respective thicknesses of the various layers 14, 15, 16 of rubber compound that form the internal wall of the tire 1.

The layer 15 is, as described hereinabove, made up partially of butyl so as to increase the air tightness of the tire. The layer 14 advantageously contains constituents that notably allow the oxygen in the air to be fixed. The reduction in thickness of these two layers is beneficial to reducing the cost of the tire as the materials of which these layers are made have costs that are not insignificant. The layer 16 provided locally on the meridian profile of the tire in the part 9 is, as explained earlier, advantageously similar to the layer 15 in terms of composition.

The thickness D at the part 9 is equal to 3.9 mm

FIG. 1c illustrates an enlargement of the region 7b of FIG. 1a and notably indicates the thickness E of rubber compound between the interior surface 10 of the cavity 8 of the tire and the point 12 of a reinforcing element 11 closest to the said surface 10. This thickness E is equal to the length of the orthogonal projection onto the surface 10 of the point 12 of a reinforcing element 11 that is closest to the said surface 10. This thickness E is the sum of the thicknesses of the various rubber compounds placed between the said reinforcing element 11 of the carcass reinforcement 2; it corresponds, on the one hand, to the thickness of the calendering layer 13 radially on the inside of the carcass reinforcement and, on the other hand, to the thicknesses e₁, e₂ of the various layers 14, 15 of rubber compound that form the internal wall of the tire 1. These thicknesses e₁, e₂ are moreover equal to the length of the orthogonal projection of a point on one surface onto the other surface of the respective layer 14 or 15 concerned.

These thickness measurements are carried out on a cross section of the tire, the latter consequently not being fitted or inflated.

The value of E measured is equal to 3.6 mm

The values of e₁ and e₂ are respectively equal to 1.7 mm and 1.7 mm

The ratio of the thicknesses D to E is equal to 1.08 and thus greater than 1.05.

Moreover, the ratio of the sum of the thicknesses of the compounds 15 and 16 to the thickness of the compound 15 is equal to 1.18 and therefore greater than 1.1.

Advantageously according to the invention, the maximum thickness of the layer 16 is comprised between 0.2 and 1 mm and is advantageously still less than 0.5 mm

The local increase in thickness between the interior surface 10 and the carcass reinforcement 2 is a step in the opposite direction to reducing the cost of the tire but does lead to a satisfactory endurance/cost compromise.

FIG. 2 is a schematic depiction of the cross section of a carcass reinforcement cord 21 of the tire 1 of FIG. 1. This cord 21 is a non-wrapped layered cord of 1+6+12 structure made up of a central nucleus formed of one thread 22, of an intermediate layer formed of six threads 23 and of an outer layer formed of twelve threads 25.

It exhibits the following characteristics (d and p in mm):

1+6+12 structure;

d₁=0.20 (mm);

d₂=0.18 (mm);

p₁=10 (mm);

d₃=0.18 (mm);

p₂=10 (mm);

(d₂/d₃)=1;

with d₂ and p₂ respectively the diameter and the helical pitch of the intermediate layer and d₃ and p₃ respectively the diameter and the helical pitch of the threads of the outer layer.

The core of the cord, composed of the central nucleus formed of the thread 22 and of the intermediate layer formed of the six threads 23, is sheathed with a rubber composition 24 based on non-vulcanized diene elastomer (in the raw state). The sheathing is obtained via a head for extrusion of the core composed of the thread 22 surrounded by the six threads 23, followed by a final operation in which the 12 threads 25 are twisted or cabled around the core thus sheathed.

The aptitude for penetration of the cord 31, measured according to the method described above, is equal to 95%.

The elastomeric composition constituting the rubber sheath 24 is produced from a composition as described above and exhibits, in the present case, the same formulation, based on natural rubber and on carbon black, as that of the calendering layers 13 of the carcass reinforcement which the cords are intended to reinforce.

FIG. 3 is a schematic depiction of the cross section of another carcass reinforcement cord 31 which can be used in a tire according to the invention. This cord 31 is a non-wrapped layered cord of 3+9 structure, composed of a central core formed of a cord composed of three threads 32 twisted together and of an outer layer formed of nine threads 33.

It exhibits the following characteristics (d and p in mm):

3+9 structure;

d₁=0.18 (mm);

p₁=5 (mm);

(d₁/d₂)=1;

d₂=0.18 (mm);

p₂=10 (mm);

with d₁ and p₁ respectively being the diameter and the helical pitch of the threads of the central core and d₂ and p₂ respectively being the diameter and the helical pitch of the threads of the outer layer.

The central core composed of a cord formed of the three threads 32 was sheathed with a rubber composition 34 based on non-vulcanized diene elastomer (in the raw state). The sheathing is obtained via a head for extrusion of the cord 32, followed by a final operation in which the 9 threads 33 are cabled around the core thus sheathed.

The aptitude for penetration of the cord 31, measured according to the method described above, is equal to 95%.

FIG. 4 is a schematic depiction of the cross section of another carcass reinforcement cord 41 which can be used in a tire according to the invention. This cord 41 is a non-wrapped layered cord of 1+6 structure, composed of a central nucleus formed of a thread 42 and of an outer layer formed of six threads 43.

It exhibits the following characteristics (d and p in mm):

1+6 structure;

d₁=0.200 (mm);

(d₁/d₂)=1.14;

d₂=0.175 (mm);

p₂=10 (min);

with d₁ the diameter of the nucleus and d₂ and p₂ respectively the diameter and the helical pitch of the threads of the outer layer.

The central nucleus composed of the thread 42 was sheathed with a rubber composition 44 based on non-vulcanized diene elastomer (in the raw state). The sheathing is obtained via a head for extrusion of the thread 42, followed by a final operation in which the 6 threads 43 are cabled around the nucleus thus sheathed.

The aptitude for penetration of the cord 41, measured according to the method described above, is equal to 95%.

Tests have been carried out on tires produced according to the invention in accordance with the depiction of FIGS. 1 and 2 and other tests have been carried out with what are referred to as reference tires.

First reference tires differ from the tires according to the invention by carcass reinforcement cords that do not have the sheathing layer 24 and by the fact that the thickness E of rubber compound between the interior surface of the cavity of the tire and the point of a reinforcing element closest to the said surface is equal to 5 mm, each of the thicknesses e₁ and e₂ being equal to 2.5 mm across the entire meridian profile of the tire.

Second reference tires differ from the tires according to the invention through the absence of the boss 9 and therefore of the layer 16.

Rolling road endurance tests were carried out on a test machine which applies a load of 4415 daN and a speed of 40 km/h on the tires, with oxygen-doped inflation of the tires. The tests were conducted on the tires according to the invention in conditions identical to those used for the reference tires. The running operations are halted as soon as the tires exhibit degradation.

The tests thus carried out demonstrated that the distances covered during each of these tests are favorable in the case of the tires according to the invention which covered a distance approximately 50% greater than that covered by the first reference tires. The second reference tires themselves covered a distance around 20% greater than that covered by the first reference tires.

Furthermore, the costs of manufacture of the tires according to the invention are not as high, the cost of materials being 3% lower in the case of the tires according to the invention as compared with the first reference tires.

Moreover, the tires according to the invention offer the advantage of being less heavy, with a 3% lightening of weight in comparison with the first reference tires.

1. A tire with a radial carcass reinforcement, made up of at least one layer of metal reinforcing elements, the tire comprising a crown reinforcement formed of at least two working crown layers of reinforcing elements which are crossed from one layer to the other, making with the circumferential direction angles of between 10° and 45°, and the crown reinforcement being radially capped by a tread, said tread being connected to two beads by two sidewalls, wherein the metal reinforcing elements of at least one layer of the carcass reinforcement are non-wrapped cords which, in the test referred to as the permeability test, return a flow rate of less than 20 cm³/min, wherein, in a radial plane, at least over part of the meridian profile of the tire, the thickness of rubber compound between the interior surface of the cavity of the tire and the point of a metal reinforcing element of the carcass reinforcement closest to said interior surface of the cavity is less than or equal to 3.8 mm, and wherein, in a radial plane, the ratio between the thickness of rubber compound measured at the circumferential mid plane between the interior surface of the cavity of the tire and the point of a metal reinforcing element of the carcass reinforcement closest to said interior surface of the cavity and the thickness of rubber compound measured in another region of the tire between the interior surface of the cavity of the tire and the point of a metal reinforcing element of the carcass reinforcement closest to said interior surface of the cavity is greater than 1.05.

2. The tire according to claim 1, wherein the metal reinforcing elements of at least one layer of the carcass reinforcement are cords having at least two layers and wherein at least one inner layer is sheathed with a layer consisting of a non-crosslinkable, crosslinkable or crosslinked rubber composition.

3. The tire according to claim 1, wherein the cords in the test referred to as the permeability test return a flow rate of less than 10 cm³/min.

4. A tire with a radial carcass reinforcement, made up of at least one layer of reinforcing elements, the tire comprising a crown reinforcement, capped radially by a tread, said tread being connected to two beads by two sidewalls, wherein the metal reinforcing elements of at least one layer of the carcass reinforcement are non-wrapped cords having at least two layers, at least one inner layer being sheathed with a layer made up of a non-crosslinkable, crosslinkable or crosslinked rubber composition, wherein, in a radial plane, at least over part of the meridian profile of the tire, the thickness of rubber compound between the interior surface of the cavity of the tire and the point of a metal reinforcing element of the carcass reinforcement closest to the said interior surface of the cavity is less than or equal to 3.8 mm, and wherein, in a radial plane, the ratio between the thickness of rubber compound measured at the circumferential mid plane between the interior surface of the cavity of the tire and the point of a metal reinforcing element of the carcass reinforcement closest to said interior surface of the cavity and the thickness of rubber compound measured in another region of the tire between the interior surface of the cavity of the tire and the point of a metal reinforcing element of the carcass reinforcement closest to said interior surface of the cavity is greater than 1.05.

5. The tire according to claim 1 or 4, wherein, in a radial plane, over at least the part of the meridian profile of the tire over which the thickness of rubber compound between the interior surface of the cavity of the tire and the point of a metal reinforcing element of the carcass reinforcement closest to said interior surface of the cavity is less than or equal to 3.8 mm, the thickness of the rubber compound forming the interior surface of the cavity of the tire is less than or equal to 1.7 mm.

6. The tire according to claim 1 or 4, wherein, in a radial plane, the ratio between the thickness of the rubber compound forming the interior surface of the cavity of the tire measured at the circumferential mid plane and the thickness of the rubber compound forming the interior surface of the cavity of the tire measured in another region of the tire is greater than 1.1.

7. The tire according to claim 1 or 4, wherein the thickness of rubber compound between the interior surface of the cavity of the tire and the point of a metal reinforcing element of the carcass reinforcement closest to the interior surface of the cavity is less than or equal to 3.8 mm over at least two thirds of the meridian profile of the tire.

8. The tire according to claim 1 or 4, wherein, in a radial plane, the part of the meridian profile of which the thickness of rubber compound between the interior surface of the cavity of the tire and the point of a metal reinforcing element of the carcass reinforcement closest to said interior surface of the cavity is greater than at least 1.05 times the thickness of rubber compound between the interior surface of the cavity of the tire and the point of a metal reinforcing element of the carcass reinforcement closest to said interior surface of the cavity of a said other region of the tire is centered on the circumferential mid plane.

9. The tire according to claim 8, wherein the axial width of said part of the meridian profile of the tire that is centered on the circumferential mid plane is greater than 20% of the axial width of the widest working layer.

10. The tire according to claim 1 or 4, wherein the metal reinforcing elements of at least one layer of the carcass reinforcement are layered metal cords of [L+M] or [L+M+N] construction that can be used as reinforcing elements in a tire carcass reinforcement, comprising a first layer C1 of L threads of diameter d₁ with L ranging from 1 to 4, surrounded by at least one intermediate layer C2 of M threads of diameter d₂ wound together in a helix at a pitch p₂ with M ranging from 3 to 12, said layer C2 being surrounded by an outer layer C3 of N threads of diameter d₃ wound together in a helix at a pitch p₃ with N ranging from 8 to 20, and wherein a sheath made of a non-crosslinkable, crosslinkable or crosslinked rubber composition based on at least one diene elastomer covers the said first layer C1 in the [L+M] construction and at least said layer C2 in the [L+M+N] construction.

11. The tire according to claim 1 or 4, wherein the crown reinforcement further comprises at least one layer of circumferential reinforcing elements.

12. The tire according to claim 1 or 4, wherein the crown reinforcement is supplemented radially on the outside by at least one additional ply, referred to as a protective ply, of reinforcing elements, referred to as elastic, oriented with respect to the circumferential direction at an angle of between 10° and 45° and in the same direction as the angle formed by the inextensible elements of the working ply radially adjacent to it.

13. The tire according to claim 1 or 4, wherein the crown reinforcement further includes a triangulation layer formed from metal reinforcing elements forming with the circumferential direction angles of more than 60°.
